(19) United States
(12) Patent Application Publication
(10) Pub. No.: US 2009/0245566 A1
(43) Pub. Date: Oct. 1, 2009

(54) Audio vibration apparatus using USB port as power inlet

(76) Inventor: Cong Ming Jheng, Taipei County (TW)

Correspondence Address: BACON & THOMAS, PLLC, 625 SLATERS LANE, FOURTH FLOOR, ALEXANDRIA, VA, 22314-1176, US

(21) Appl. No.: 12/078,374

(22) Filed: Mar. 31, 2008

(51) Int. Cl. H04R 1/02

(52) U.S. Cl. 381/386

(57) ABSTRACT

An audio vibration apparatus using a USB port as a power inlet primarily comprises a housing, a circuit board, an electromagnetic converting device and a soft pad. Therein the electromagnetic converting device is constructed from an electromagnetic converting coil assembly, an upper metal element and a lower metal element. Thereby, an external signal can be transmitted through the USB port settled on the circuit board to a processing unit of the circuit board so as to drive the electromagnetic converting device to generate a vibration frequency that resonates a soft pad to impact a plane object and therefore give off a sound.

### BACKGROUND OF THE INVENTION

1. Technical Field

The present invention relates to an audio vibration apparatus using a USB port as a power and audio inlet.

2. Description of Related Art

As there are manifold loudspeakers on the market, including portable speakers and speakers for working with personal desktop computers or sound systems, each of the loudspeakers has its specialized occasion. However, as for a portable speaker, though it is convenient in use and light-weighted, the sound it performs is generally weak and thin. Speaking to a speaker for working with a personal desktop computer, a laptop or a sound system, a power wire is necessary for providing the power required by the speaker itself in addition to an audio signal wire connected thereto. The power wire and the audio signal wire, plus other wires connected to the personal desktop computer, the laptop or the sound system, can easily be entangled mutually and cause disorganisation that inconveniences a user.

### SUMMARY OF THE INVENTION

The present invention has been accomplished under these circumstances in view to provide an audio vibration apparatus using a USB port as a power and audio inlet, whereby external power and audio signals can be transmitted to a circuit board in the audio vibration apparatus so as to drive an electromagnetic converting device to generate a vibration frequency that in turn resonates a soft pad so that the soft pad can impact a plane object and give off a sound.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is an appearance diagram of the disclosed subject matter of the present invention;

FIG. 2 is an exploded view of the disclosed subject matter of the present invention;

FIG. 3 is a partial schematic drawing of the disclosed subject matter of the present invention;

FIG. 4 is a perspective view of the disclosed subject matter of the present invention;

FIG. 5 is a sectional view of the disclosed subject matter of the present invention;

FIG. 6 is a schematic drawing illustrating a status of use of the disclosed subject matter;

FIG. 7 is a schematic sectional view showing the status of use of the disclosed subject matter;

FIG. 8 is an applied view of the present invention; and

FIG. 9 is another applied view of the present invention.

### DETAILED DESCRIPTION OF THE PREFERRED EMBODIMENT

The features and functions of the technical means and structures implemented in the present invention in the attempt to achieve the aforementioned objectives and effects are to be illustrated by the preferred embodiments described hereinafter.

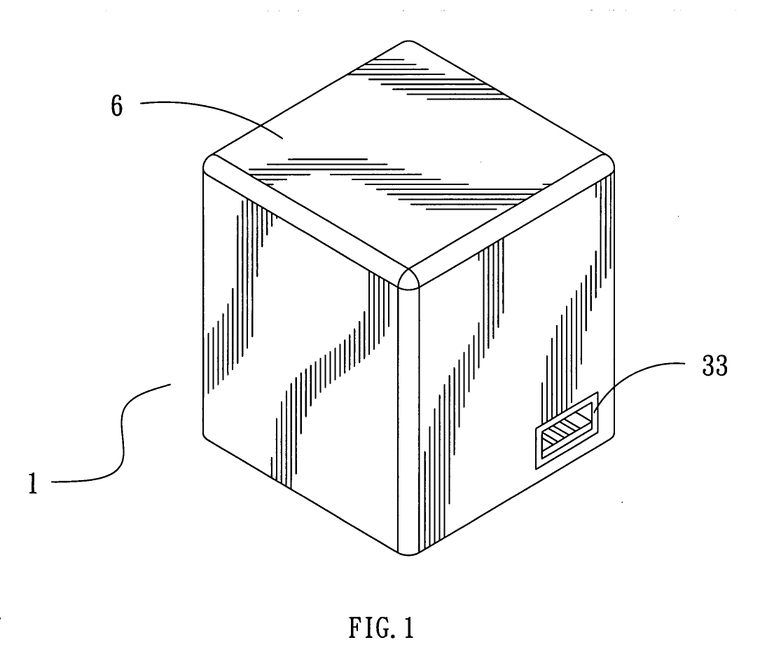

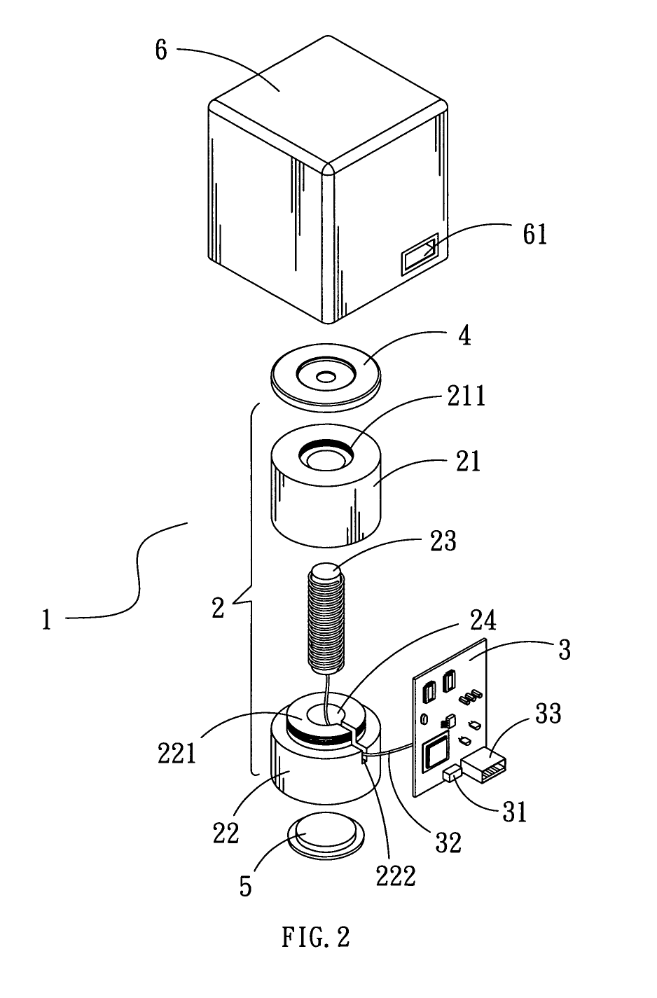

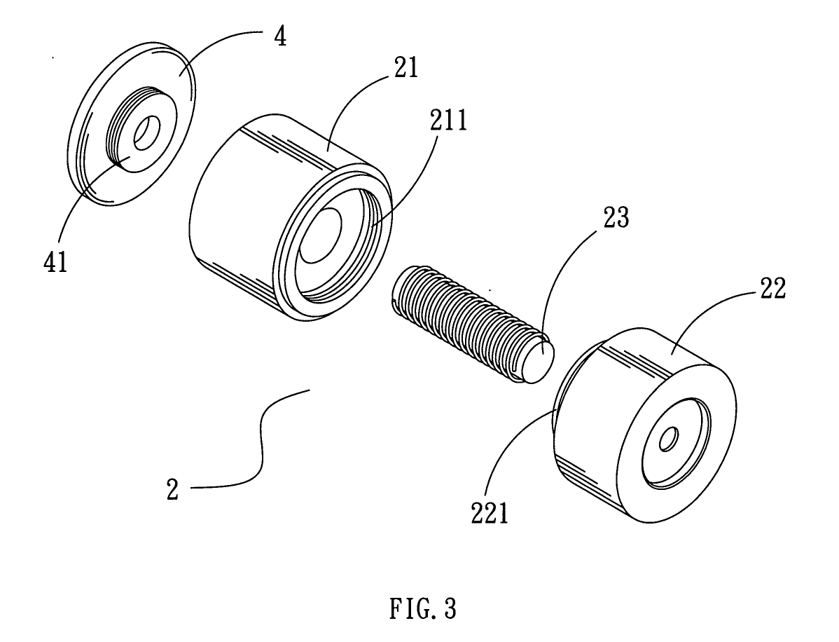

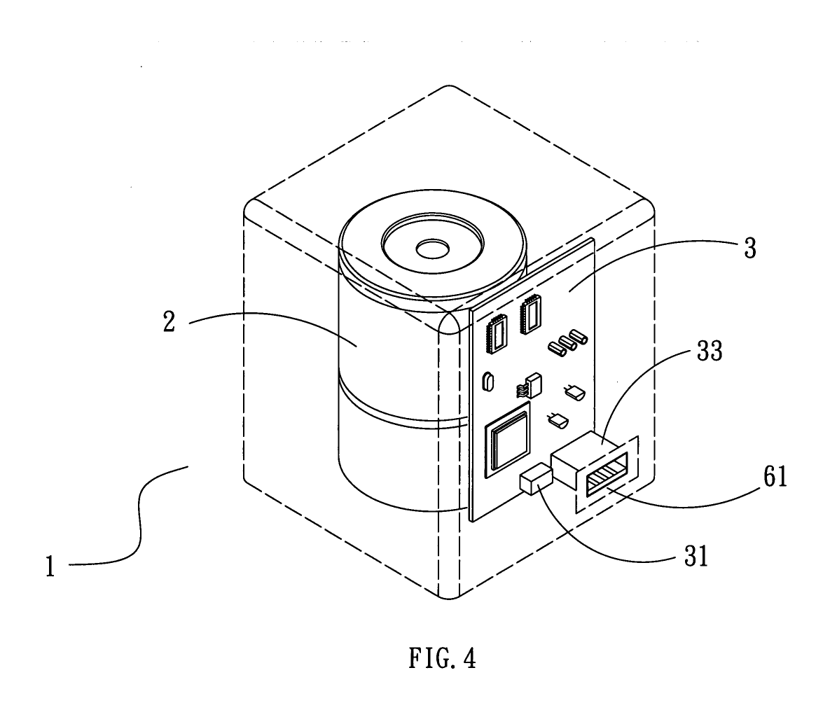

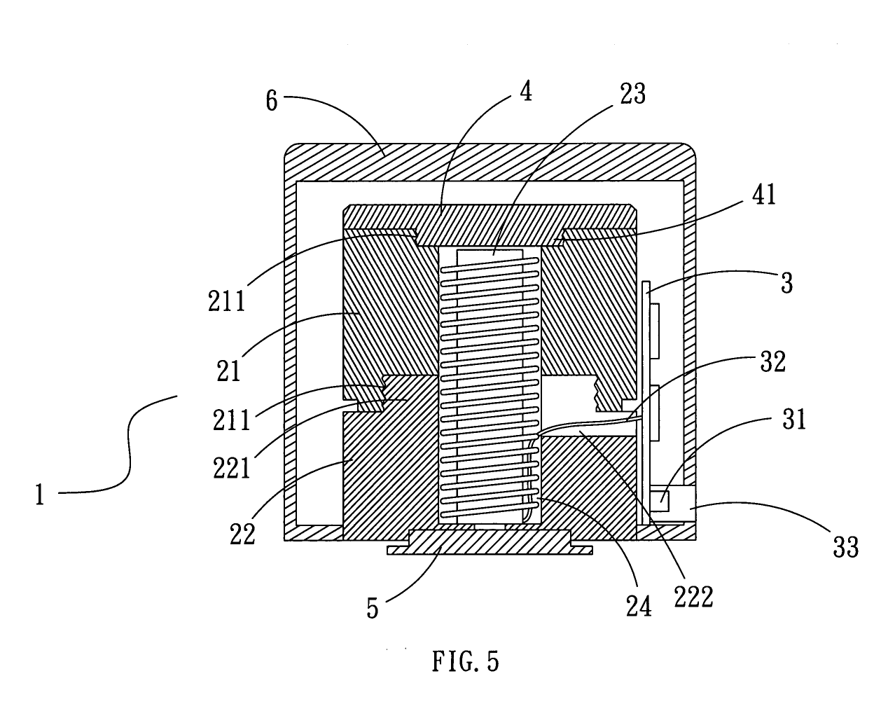

Please refer to FIGS. 1, 2, 3, 4 and 5 for the appearance diagram, exploded view, partial schematic drawing, perspective view, and sectional view of the present invention, respectively. Therein, it is obvious that the disclosed audio vibration apparatus 1 is primarily composed of an electromagnetic converting device 2, a circuit board 3, a cover 4, a soft pad 5 and a housing 6. The electromagnetic converting device 2 comprises an upper metal element 21, a lower metal element 22, and an electromagnetic converting coil assembly 23. The electromagnetic converting coil assembly 23 is settled in an accommodating space 24 defined by the assembled upper metal element 21 and lower metal element 22. The upper metal element 21 has two ends thereof formed with threads 211 for being screwed and thus assembled with a screw segment 221 of the lower metal element 22 and a screw segment 41 of the cover 4, respectively. The lower metal element 22 is formed with a groove 222 for receiving a wire 32 connected between the circuit board 3 and the electromagnetic converting coil assembly 23. The soft pad 5 is further settled at a lower side of the lower metal element 22. Moreover, a processing unit 31 and a USB port 33 are provided on the circuit board 3. The hole 61 is such formed at an outer side of the housing 6 that the USB port 33 is positionally corresponding to the hole 61.

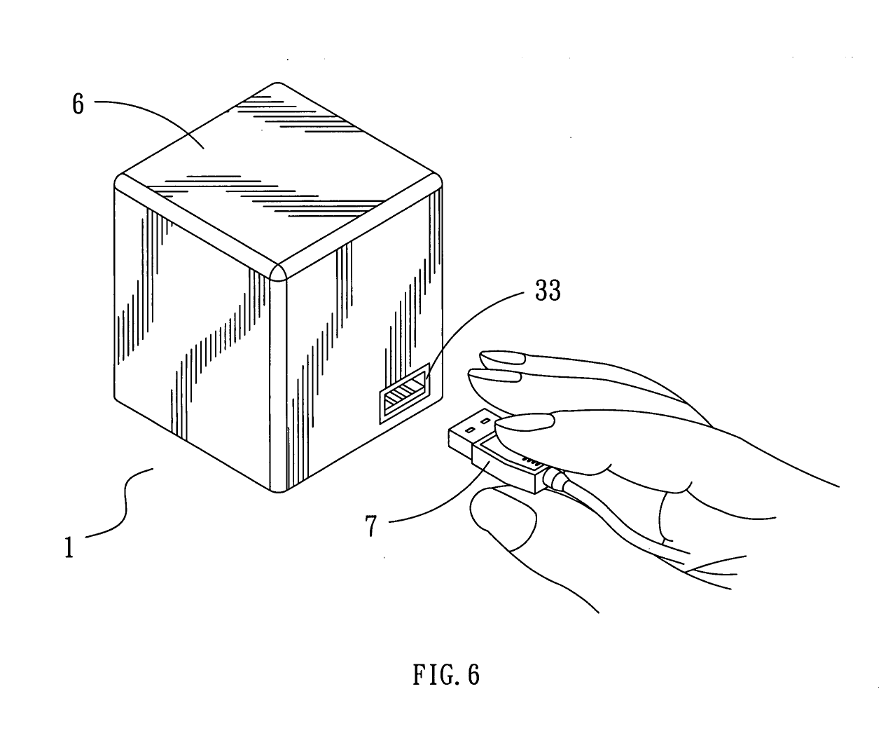

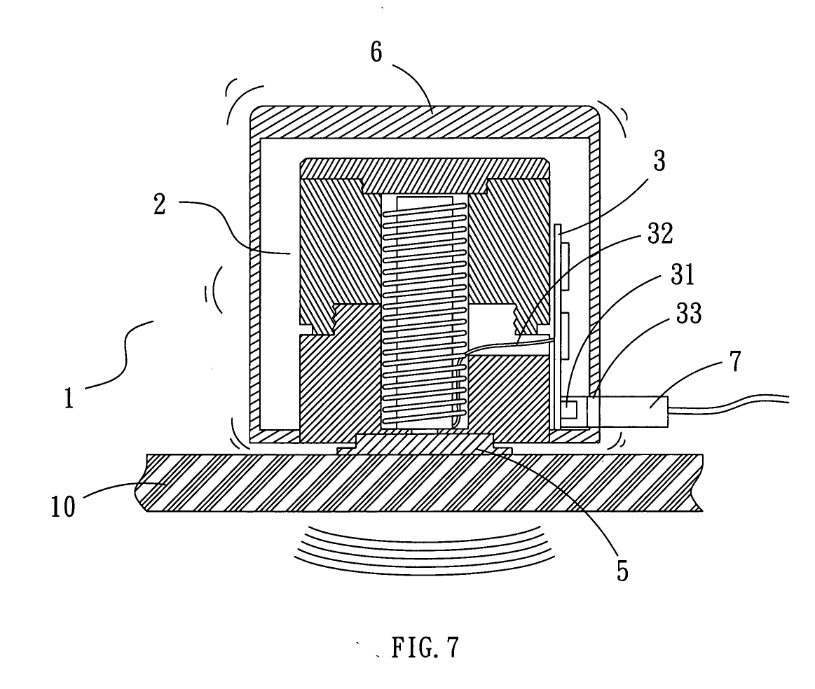

Now referring to FIGS. 6 and 7 for the applied views of the present invention. Therein, when the USB port 33 at the side of the housing 6 of the audio vibration apparatus 1 is connected with a USB connector 7, external power and audio signals are transmitted to the processing unit 31 on the circuit board 3 through the wire 32. Then a signal is transmitted to the electromagnetic converting device 2 by the circuit board 3 so that the electromagnetic converting device 2 can convert the signal into a vibration frequency. At this time, the soft pad 5 at the lower side of the electromagnetic converting device 2 is resonated by the vibration frequency of the electromagnetic converting device 2 so that the resonance of the soft pad 5 can impact a sound-giving portion 10 on a plane object such as a table, a chair, a Buddhist statue, an utensil, or an art work that has a plane portion and therefore the audio vibration apparatus 1 can give off a sound via the sound-giving portion 10.

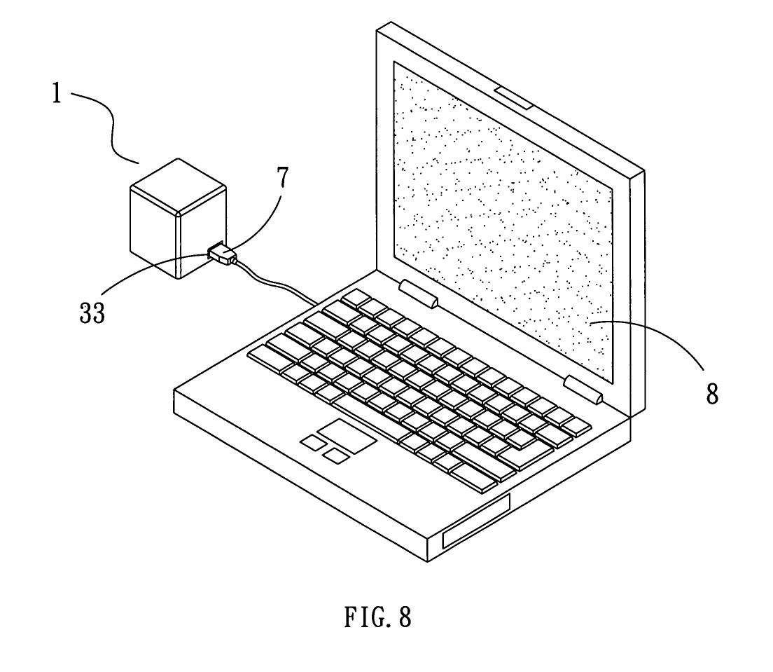

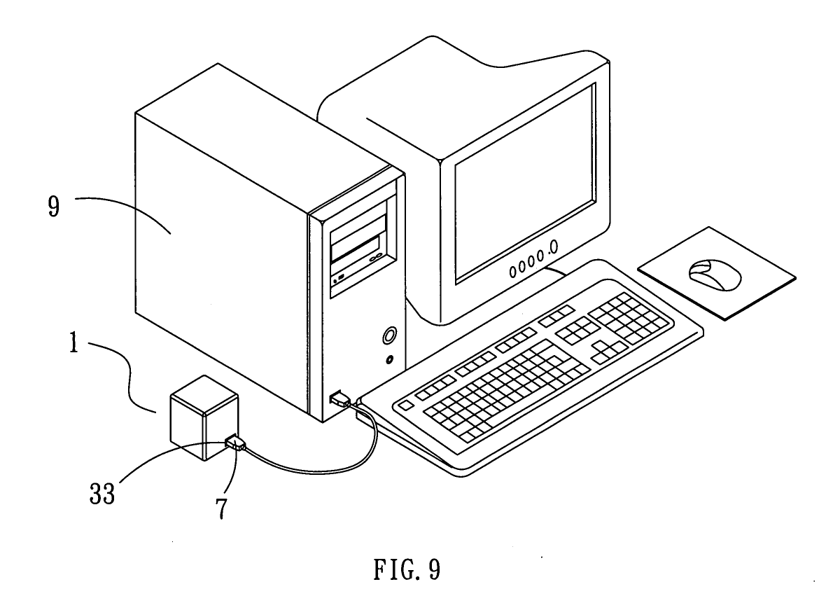

Please see FIGS. 8 and 9 for the applied views of the present invention. Therein, the external USB connector 7 is connected to the USB port 33 at a side of the audio vibration apparatus 1 so that a music to be played by a laptop 8 or a desktop computer 9 can be played through the audio vibration apparatus 1. Since the audio vibration apparatus 1 can not only receive the external audio signals but also the power required by the audio vibration apparatus 1 through the USB port 33, the convenience and the practicability of the audio vibration apparatus 1 are significantly enhanced.

Although the particular embodiment of the invention has been described in detail for purposes of illustration, it will be understood by one of ordinary skill in the art that numerous variations will be possible to the disclosed embodiments without going outside the scope of the invention as disclosed in the claims and the equivalents.

What is claimed is:

1. An audio vibration apparatus using a USB port as a power inlet, comprising:
a housing, for enclosing and protecting components settled therein and having a hole formed at one side thereof;
a circuit board, mounted with a processing unit and a USB port, wherein the USB port positionally corresponds to the hole of the housing and the circuit board is settled inside the housing;
an electromagnetic converting device, constructed from an electromagnetic converting coil assembly, an upper metal element and a lower metal element and serving to convert a signal given by circuit board into a vibration frequency;
a cover, settle at an upper side of the upper metal element; and
a soft pad, settle at a bottom of the lower metal element and serving to transmit the vibration frequency generated by the electromagnetic converting device so that the vibration frequency can drive the soft pad to impact a plane object and in turn give off a sound.

2. The audio vibration apparatus of claim 1, wherein the plane object to be impacted by the soft pad is a table, a chair, a Buddhist statue, an utensil, or an art work that has a plane portion.

3. The audio vibration apparatus of claim 1, wherein the lower metal element is formed with a groove for accommodating a signal wire connected between the circuit board and the electromagnetic converting coil.

4. The audio vibration apparatus of claim 1, wherein the upper metal element has one side thereof formed with threads and the lower metal element has a screw segment extended therefrom so that the upper and lower metal elements can be screwed and assembled together.

5. The audio vibration apparatus of claim 1, wherein the cover has a screw segment and the upper metal element has one side thereof formed with threads so that the cover and the upper metal element can be screwed and assembled together.

6. The audio vibration apparatus of claim 1, wherein an accommodating space is defined by the assembled upper metal element and the lower metal element for receiving the electromagnetic converting coil.

7. The audio vibration apparatus of claim 1, wherein the USB port is capable of receiving an external audio signal in addition to receiving a power.

8. The audio vibration apparatus of claim 1, wherein the electromagnetic converting coil assembly is received in an accommodating space defined by the combined upper metal element and the lower metal element and the upper metal element has two ends thereof formed with threads for being screwed with screw segments of the lower metal element and the cover, respectively.
